(19) United States
(12) Patent Application Publication
(10) Pub. No.: US 2025/0091282 A1
(43) Pub. Date: Mar. 20, 2025

(54) MANDREL FOR THERMOPLASTIC TUBE MATERIAL, BENDING MACHINE AND METHOD FOR BENDING SUCH TUBE MATERIAL

(71) Applicant: WAFIOS Aktiengesellschaft, Reutlingen (DE)

(72) Inventors: Bernd Schoser, Sonnenbuehl (DE); Julian Pandtle, Hechingen (DE)

(21) Appl. No.: 18/889,693

(22) Filed: Sep. 19, 2024

(30) Foreign Application Priority Data
Sep. 19, 2023 (DE) 102023125375.1

(51) Int. Cl. B29C 53/08; B29C 53/82; B29C 53/84

(52) U.S. Cl. CPC B29C 53/083; B29C 53/82; B29C 53/84; B29K 2995/0082

(57) ABSTRACT

A mandrel for thermoplastic tube material having an internal cross-section. The mandrel includes a mandrel head which is bendable about a longitudinal axis in order to stabilize the tube material in the internal cross-section during a bending operation. A switching device is provided which acts on the mandrel head and switches the mandrel head to a state in which it is resistant to flexing at least relative to the vertical, in order to support the heated tube material during conveying.

### RELATED APPLICATIONS

The present application claims priority to German Application No. 102023125375.1, filed Sep. 19, 2023, which is hereby fully incorporated herein by reference in its' entirety.

### TECHNICAL FIELD

The invention relates to a mandrel for thermoplastic tube material having an internal cross-section, which comprises a mandrel head that is flexible in relation to a longitudinal axis in order to stabilize the tube material in the internal cross-section during a bending operation. The invention further relates to a bending machine and a method for bending thermoplastic tube material comprising an inner cross-section, which is bent in sections in a bending station and stabilized in the inner cross-section with a mandrel during a bending operation, wherein the tube material is previously heated in the segment to be bent next and then displaced to the bending station.

### BACKGROUND

Tube material made of thermoplastic or thermoplastic fiber composite must be heated and thus softened before bending. Furthermore, it is necessary to stabilize the inner cross-section of the tube material to prevent it from being pinched or constricted during bending.

Generically, DE 10 2012 005 973 A1 discloses for stabilizing the inner cross-section the above-mentioned mandrel, which comprises a mandrel head that is flexible with respect to a longitudinal axis. It is attached to a guide rod, for example, and is located in the segment of the tube that is being bent during the bending process. It can flex in all directions so that it can follow bends in the tube material in all possible directions in order to stabilize the tube material in the inner cross-section. FIGS. 7c to 7h of the publication show various possibilities for a mandrel head that is flexible in all directions. For example, it can be designed as a scaly mandrel.

Since the tube material loses rigidity due to heating, there is an additional problem in that the heated and softened material has lost rigidity during transport to the bending device. DE 10 2018 003 235 A1 therefore provides for the heated tube material to be supported from the outside during such transport, for example by suitable multi-axis robots.

There is a need in the art to simplify bending of plastic tubes and, in particular, to provide support for the heated and softened thermoplastic tube material in a simpler way while providing maximum freedom for bending operations.

### SUMMARY

According to embodiments of the present disclosure, a mandrel for thermoplastic tube material having an internal cross-section comprises a mandrel head in order to stabilize the tube material in the internal cross-section during a bending operation. In a first (flexible) state the mandrel head is flexible in at least one plane and stabilizes the tube material in the inner cross-section during the bending operations process, of which there is at least one. The mandrel further comprises a second (rigid) state in which the head is rigid in relation to at least one vertical plane in order to support the heated tube material while moving, e.g. being transferred from a heating station to a bending station. A control system controls switching device that switches the mandrel head between the two states and controls the switching device to switch the mandrel head to the flexible state for bending, such that the at least one plane is the bending plane in which the bend is to be made.

This design of the mandrel head provides internal stabilization of the tube material when that is heated and softened. The mandrel now has a dual function. On the one hand, it stabilizes-when in the flexible state—the inner cross-section of the tube material during the bending process, as is also the case with conventional mandrels. At the same time, however, it now supports-when in the rigid state—the tube material vertically when that is being transported. External support by means of complex multi-axis robots is therefore no longer necessary for transport. At the same time, it is now easy to process relatively thin-walled tube materials, which used to be problematic when it came to external support, as that material could be pinched. The mandrel thus has the dual function of (conventionally) stabilizing the inner cross-section during the bending process and additionally supporting the heated and softened tube material during transport, for example to the bending unit. This means that separate external support of the tube material is no longer necessary, reducing the effort involved and minimizing rejects.

Two variants are possible to provide the supporting effect. In embodiments of a first variant, the mandrel head is designed so that it can be deflected in all directions in the flexible state while in the rigid state the mandrel head extends stiff along the longitudinal axis. In embodiments this is realized by providing a mandrel head composed of individual elements or scales along a mandrel head extension and by applying a tensile force bracing the individual elements or scales of the mandrel head against each other to make the mandrel head stiff. In other embodiments, a supporting element is pushed into the mandrel head or slid over the mandrel head. Of course, a combination of these embodiments is possible. A guide rope is particularly useful for bracing, which then acts as a pull rope and pulls a head piece of the mandrel head backwards so that the other elements of the mandrel head can no longer move and are forced to align to each other along the shortest possible line, which is a straight line, and can no longer deviate from this orientation.

In embodiments of a second variant, the mandrel head is rigid in some planes and flexible in other planes and gets rotationally oriented differently in the flexible state and in the rigid state, i.e., for transport and for bending. In embodiments the mandrel head is rigid in at least one plane and can be flexed in at least one other plane. These are referred to below as the stiffened plane and the flexible plane. The mandrel head cannot be deflected in the stiffened plane, but it can in the flexible plane. For transporting, i.e., supporting, the tube material, the switching device rotates the mandrel head so that the stiffened plane coincides with the vertical, i.e., the mandrel head supports the tube material against the vertical. This is the rigid state. The fact that the mandrel head remains flexible in the e.g., horizontal plane, has no further significance, since the main forces acting on the softened tube material are due to gravity, i.e., act along the vertical. For bending, on the other hand, the mandrel head is rotated so that the flexible plane coincides with the plane in which the bending is carried out. This is the flexible state. The mandrel head can thus easily follow the deflection of the tube material during bending and stabilize the tube material in the inner cross-section without counteracting the bending force. Other embodiments are inverted and the mandrel head is generally rigid but flexible in at least one plane which is the flexible plane. Then the flexible plane is brought into coincidence with a bending plane of the bend process. Of course, combinations are possible.

The switching device generally includes a mechanical drive (e.g., including a motor) acting on the mandrel head. Preferably, the mandrel also includes a mandrel drive for moving the mandrel longitudinally, and the switching device is combined with the mandrel drive to form an assembly. The mandrel drive can also be assigned to the bending machine.

A bending machine according to an embodiment of the invention includes the mandrel and the switching device for switching the mandrel head.

A bending method utilizes the mandrel. Embodiments of the method include the following steps: heating a segment of the tube material to be bent to a bend located in a bending plane; moving the tube material to a bending station; supporting the segment by means of the mandrel having a mandrel head inserted into the inner cross-section along the segment, wherein the mandrel head is in a rigid state by being resistant to flexing at least in the vertical; switching the mandrel head to be flexible at least relative in the bending plane, and bending the tube material to the bend in the segment. In this method the mandrel is switched between the rigid state, which is used for transporting the heated tube material, and the flexible state, which is used for bending.

In embodiments of the method such switching is provided by acting on the mandrel head. This can be done by changing the mechanical properties of the head or by rotating a mandrel head which has anisotropic flexibility characteristics (as mentioned above).

However, the mandrel can be switched between the rigid state, which is used for transporting the heated tube material, and the flexible state, which is used for bending, even without changing properties of the mandrel head or rotating the mandrel head. Such method includes the following steps: heating a segment of the tube material to be bent to a bend located in a bending plane; moving the tube material to a bending station; while moving, supporting the segment by means of a mandrel having a rigid guide rod and a flexible mandrel head, wherein the mandrel is positioned such that rigid guide rod is located in the segment and the flexible mandrel head is outside the segment; inserting the segment into the bending station and stabilizing the segment against the vertical by means of the bending station; moving the flexible mandrel head to be located in the stabilized segment, and bending the tube material to the bend in the segment. In these embodiments, the mandrel head can be conventional, however, is controlled regarding its longitudinal position in a particular way. For stabilizing the tube material in the heated segment, the rigid guide rod is placed in this segment. That means that the flexible mandrel head is advanced beyond the segment, i.e., further out relative to normal operation. Once the segment is located and supported in the bending station, the mandrel is retracted such that the flexible head is located in the segment. Then, the bending operation can be carried out.

It is understood that the features mentioned above and those to be explained below can be used not only in the specified combinations, but also in other combinations or on their own, without leaving the scope of the present invention.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

In the following, the invention will be explained in more detail using examples with reference to the attached drawings, which also reveal features essential to the invention. These embodiments are for illustration purposes only and should not be interpreted as limiting the invention. For example, a description of an embodiment with a plurality of elements or components should not be interpreted as requiring all of those elements or components for implementation. Rather, other embodiments may include alternative elements and components, fewer elements or components, or additional elements or components. Elements or components of different embodiments can be combined with one another, unless otherwise stated. Modifications and variations described for one of the embodiments may also be applicable to other embodiments. To avoid repetition, identical or corresponding elements in different figures are designated by the same reference signs and are not explained more than once. The figures show:

FIG. 1 is an isometric view of a bending machine for plastic tubes with a heating device and a mandrel;

FIG. 2 is a schematic cross-sectional view of an exemplary mandrel;

FIG. 3 is a schematic cross-sectional view of an exemplary mandrel including a stabilizing sleeve that can be slid over the guide rod 16 and the mandrel head 18 in the longitudinal direction;

FIG. 4 is a schematic cross-sectional view of an exemplary mandrel including an internal stiffening sleeve that is advanced or retracted by the mechanical drive of the switching device;

FIG. 5 is a schematic cross-sectional view of an exemplary mandrel including an expansion element at the tip of the mandrel that expands radially when the mandrel head is made resistant to bending;

FIG. 6 is a schematic cross-sectional view of an exemplary mandrel with an expansion element at the area of the guide rod hat expands radially when the mandrel head is made resistant to bending; and

FIGS. 7-10 depict various states of the exemplary mandrel of FIG. 2, present when bending the plastic tube.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

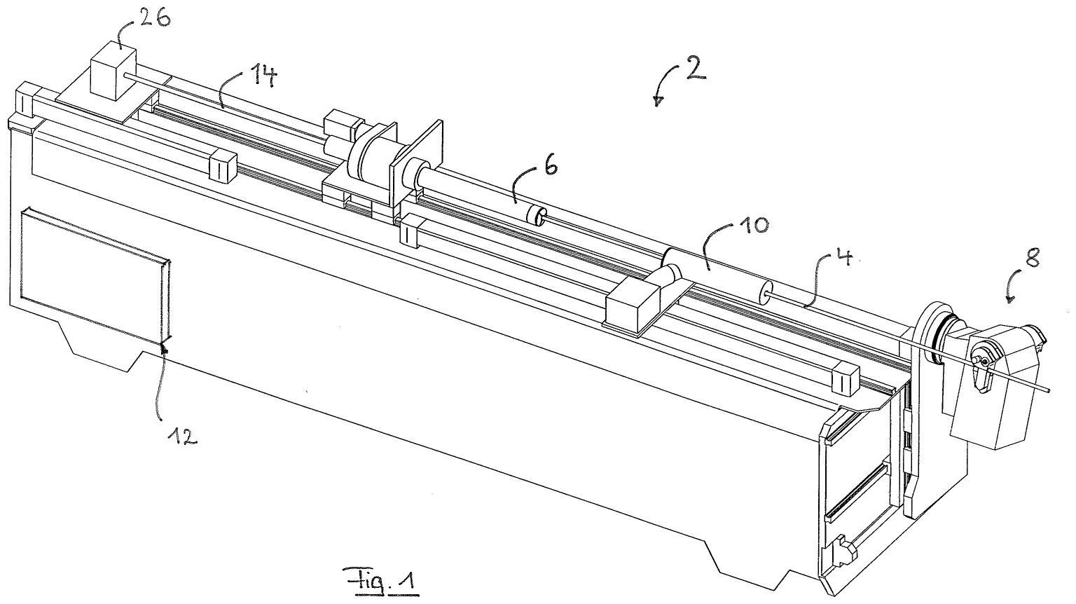

FIG. 1 schematically shows a bending machine 2 for bending thermoplastic tubes 4. The tubular material 4 is held by a tube gripper 6. At the end of the bending machine 2 is a bending unit 8 that bends the plastic tube 4. A heating device 10 is located in front of the bending unit 8, which heats the tube material 4 so that bending is possible. The heating device 10 heats the tube material 4 to the temperature required for the bending process. The tube is then fed to the bending unit 8 for bending.

The bending machine 2 guides the workpiece, a thermoplastic tube material 4, on a mandrel 14 that acts as an inner mandrel and is inserted into the interior of the plastic tube. The mandrel 14 supports the thermoplastic material. Unlike metal tube material, the thermoplastic material 4 must be heated to make it bendable. This naturally causes it to lose some of its rigidity.

The heating device 10 heats a segment of the tube material 4 where a bend will be made later. A longitudinal section of the tube material 4 is heated and then advanced to the bending unit 8, which performs the bending on the heated and softened thermoplastic material. The mandrel 14 supports the plastic tube material during transport, in particular along the longitudinal section that has been heated in the heating device 10. In the bending machine 2 of FIG. 1, the transport is a forward feed along the longitudinal axis, which is defined by the machine bed. In the case of different bending machines, the transport can proceed differently. This will be discussed later. During transport, the heated section is stabilized by the inserted mandrel 14.

The operation of the bending machine 2 and in particular the displacement of the tube gripper 6 via its drive, which is not further designated, and the control of the bending unit 8 is controlled by a control device 12, which for example comprises a processor and has an interface for inputting a bending program according to which the bending machine 2 then operates.

FIG. 2 shows a schematic cross-sectional view of an example of the mandrel 14. It comprises a guide rod 16 and a mandrel head 18, which is flexible to all sides with respect to the longitudinal axis defined by the guide rod 16. This deflection allows the mandrel head 18 to lie in the segment of the tube material 4 that is being shaped by the bending unit 8. The flexibility of the mandrel head 18 allows it to follow the resulting bend of the tube during the bending process, thereby stabilizing the tube material 4 in the inner cross section so that it is not pinched or constricted.

Mandrel heads that can flex in this way are known, for example from DE 10 2012 005 973 A1. They can be used here, but are now designed to be able to be stiffened. The mandrel head 18 of the mandrel 14 shown in FIG. 2 is designed as an example of a scaled mandrel. It consists of individual scales 20 and has a pulling cable 22 that runs from the head piece 24 of the mandrel head 18 through the mandrel head 18 and the guide rod 16 to their rear, i.e., foot-side end. This end is located in the mandrel drive 26, which, as shown in FIG. 1, can be moved along the longitudinal axis of the bending machine 2 in order to be able to move the mandrel 14 with respect to the tube gripper 6 and thus the plastic tube 4. The mandrel drive 26 is controlled by the control device 12.

The mandrel 14 also has a device for stiffening the mandrel head 18, so that the latter becomes resistant to bending and acts as a continuation of the guide rod 16 along its longitudinal axis. For this purpose, a switching device 27 comprising a mechanical drive is provided in or on the mandrel drive 26, which drive tensions the pulling cable 22 by pulling the pulling cable foot 28 out of the foot-side end of the guide rod 16 in the direction of the arrow schematically shown in FIG. 2, so that a pulling cable head 29, which is anchored at its other end in the head piece 24, braces the head piece 24 and the scales 20 of the mandrel head 18 against the guide rod 16, thereby stiffening the mandrel head 18. The mechanical drive may comprise a pulling motor in this embodiment.

In this state, the mandrel head 18 can no longer bend, but instead takes on a rigid, straight rod shape. To do this, the scales 20 do not have to be specially designed, as long as the shortening in the center (tension in the pulling cable 22) pulls the mandrel head into a straight line. However, the scales or links (in the case of a link mandrel) preferably also have a centering structure that additionally aligns the scales or links along a straight line when tensile stress is applied.

The bending-resistant state of the mandrel head 18 is then established by the switching device 27 under the control of the control device 12 when a heated segment of the tube material 4 is to be supported, for example when such a segment, which has been heated in the heating device 10, is advanced to the bending unit 8. Once such a section has arrived at the bending unit 8, the switching mechanism 27 releases the stiffening, i.e., in FIG. 2 the tension in the pulling cable 22, and the mandrel head 18 can follow the subsequent bending that the bending unit 8 performs on the tube material 4 and has a stabilizing effect on the inner cross-section.

The principle of a mandrel 14 comprising a mandrel head 18, which can be switched between a rigid state and a flexible state, can also be achieved by other means as an alternative to the embodiment of FIG. 2. FIG. 3 shows a design comprising a stabilizing sleeve 30 that can be slid over the guide rod 16 and the mandrel head 18 in the longitudinal direction. When the mechanical drive of the switching device pushed the stabilizing sleeve 30 forward in the direction of the double arrow 32 up to the head piece 24, the entire mandrel head 18 gets rigid. Unlike the variant of FIG. 2, displacing the stabilizing sleeve 30 also allows the mandrel head 18 to be stiffened only in parts, depending on how far the switching device advances the stabilizing sleeve 30 over the mandrel head 18. The stabilizing sleeve 30 is driven by the mechanical drive of the switching device 27 in/on the mandrel drive 26. Unlike in FIG. 2, the cable running inside the mandrel head 18 and the guide rod 16 is no longer a pulling cable, but a pure guide cable 34 that is no longer tensioned or released by the switching device 27. To switch to the flexible state, the switching mechanism pulls back the stabilizing sleeve 30 along the direction of the double arrow 32.

The guide sleeve 30 does not have to surround the mandrel head 18 on completely. It is also possible to design the guide sleeve 30, for example, in the form of a helically running component or as a slotted sleeve-shaped component with a continuous lateral slot.

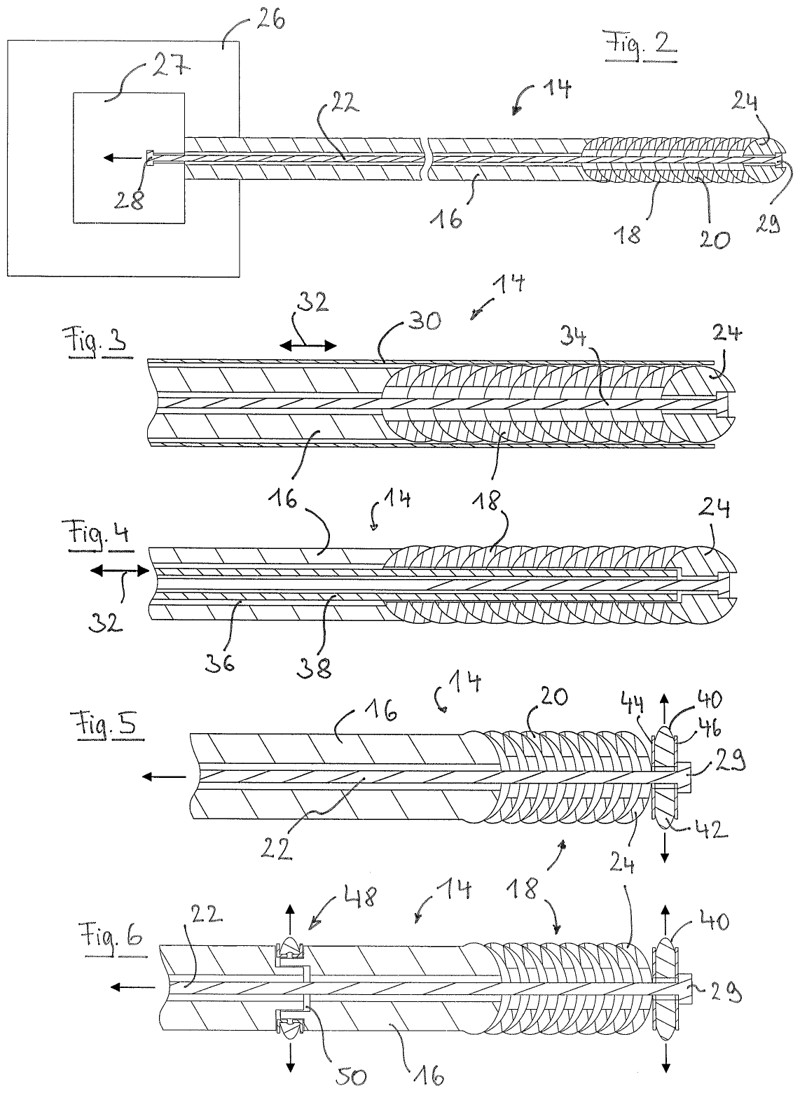

In the design of FIG. 4, instead of the external stabilizing sleeve 30, an internal stiffening sleeve 38 is advanced or retracted by the mechanical drive of the switching device 27 along the direction of the double arrow 32 through an opening 36 longitudinally extending in the guide rod 16 and in the mandrel head 18 up to the head piece 24. This also allows the switching device 27 to switch the mandrel head 18 between rigid and flexible. With a suitable design, pressurization by means of compressed fluid or compressed air is an option for achieving the stiffening effect. The mechanical drive may comprise a pressure pump in this embodiment.

Of course, the designs of FIGS. 2 and 3, 2 and 3, 3 and 4, and 4 and 3 and 2 can also be combined to achieve a particularly strong stiffening of the mandrel head 18.

Furthermore, for all embodiments, it is possible to also design the mandrel head 18 as a link mandrel head or in the form of an elastic spring element, which can be made resistant to bending by pull tension or by stiffening elements.

FIGS. 5 and 6 show designs of the mandrel 14 with an additional element provided at the tip of the mandrel head 18 (FIG. 5) or alternatively or additionally in the area of the guide rod 16 (FIG. 6). It is an expansion element that expands radially when the mandrel head 18 is made resistant to bending by tensioning the pulling cable 22. In the embodiments shown in FIG. 5, the expansion element 40, which is provided at the tip of the mandrel head 18, is formed by an elastomer pad 42, which is enclosed by two perforated disks 44, 46 and is crushed and thus radially expanded by the tension in the pulling cable 22. This serves to brace the mandrel head 18 inside the tube and to support the tube against torsional forces. The alternatively or additionally provided expansion element 48 serves the same purpose. It is located in the area of a split 50 in the guide rod 16, which split is configured such that the guide rod 16 retains its longitudinal guiding property but can be compressed in the axial direction in order to expand the expansion element 48 radially by means of tension applied by the pulling cable 22, and thus to brace the mandrel 14 in the interior of the tube material 4 at a different (or further) location.

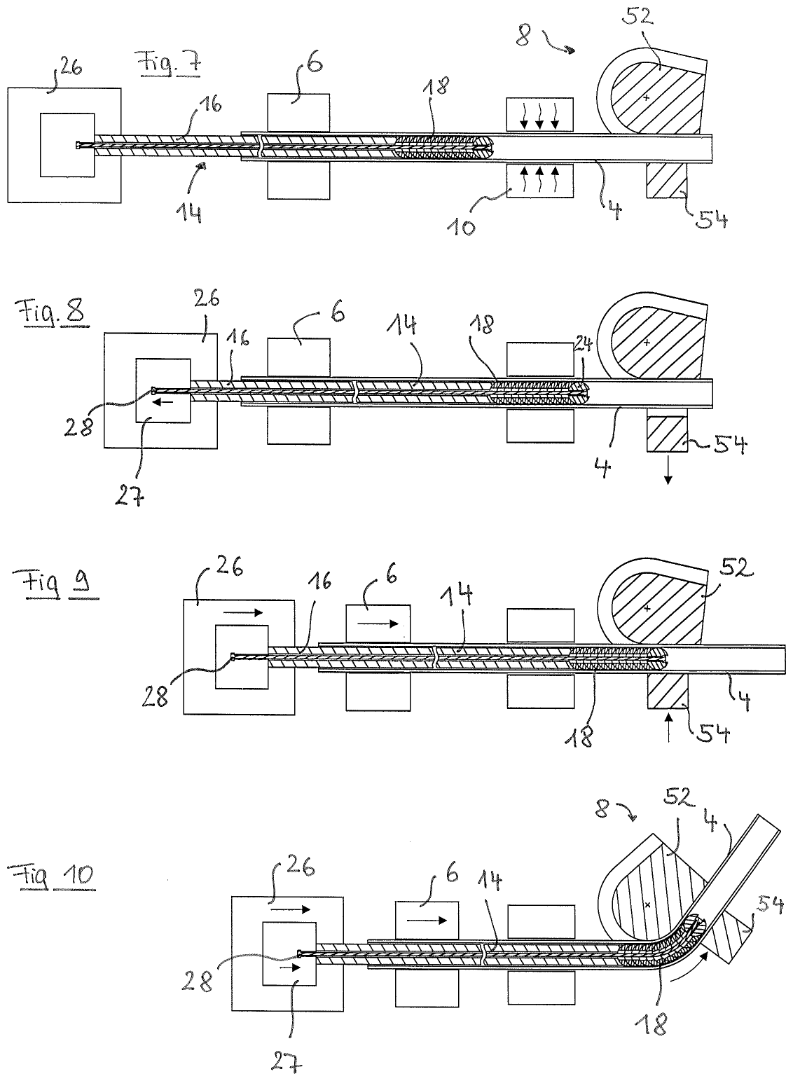

FIGS. 7 to 10 show the use of mandrel head 18 in a bending process. In the state of FIG. 7, the tube material 4 is inserted into the bending machine 2 and is held at its rear end (remote from the bending unit) by the tube clamp 6 and at its front end by the bending unit 8, since the tube material 4 is pressed against a bending disk 52 by a closed clamping jaw 54. In this state, the heating device 10 heats a segment of the tube material 4. The mandrel drive 26 sets the mandrel 14 so that the mandrel head 18 is not yet in the area of the heating device 10. This is optional, but has the advantage that the heating device 10 only has to heat the tube material 4 and no heat is dissipated to the internally located mandrel head 18, i.e., no heat is dissipated through the mandrel head 18.

Once the tube material 4 has been sufficiently heated to its softening point, the mandrel drive 26 first advances the entire mandrel 14 until the mandrel head 18 is located in the now heated and softened segment of the tube material 4. This condition is shown in FIG. 8. Subsequently, as indicated by an arrow in FIG. 8, the control device 27 biases the tension cable foot 28 against the guide rod 16, causing the head 24 to be biased towards the guide rod 16 and the mandrel head 18 is stiffened. Now the clamping jaw 54 can be released and the plastic tube 4 and the mandrel 14 are advanced synchronously until the heated segment of the tube material 4 comes to lie in the area of the bending unit 8, i.e., the bending disk 52 and the clamping jaw 54, which is then closed. In order to ensure that the tube material 4 and the mandrel 14 are advanced synchronously, the tube gripper 6 and the mandrel drive 26 are actuated synchronously in the corresponding manner. The mandrel head 18 remains rigid during this process, i.e., the switching mechanism continues to hold the foot of the traction cable under tension against the guide rod 16.

For the subsequent bending process, however, this tension is released, i.e., the switching mechanism 27 switches the mandrel head 18 to a slack state. For example, it loosens the foot of the pull rope 28. The bending unit 8 now performs a bend, which the now flexible mandrel head 18 follows, while the plastic tube is stabilized in the inner cross-section. Of course, the tube material 4 and the mandrel 14 are fed accordingly to match the bending process, which is done by a corresponding control of the tube clamp 6 and mandrel drive 26.

Once the bending is complete, the mandrel 14 can be retracted to execute the process again according to FIGS. 7 to 10 if another bend is to be made on the workpiece, namely the tube material 4.

FIGS. 8 to 9 show that the mandrel head 18 stabilizes the tube material 4, after it has been heated and plasticized in the heating device 10, in relation to the vertical, so that it cannot sag downwards during feed. In the embodiments shown in FIGS. 7 to 10, this is achieved by switching the mandrel head 18 between a state in which it is flexible in all directions and a state in which it is rigid in all directions, and back into the flexible state for the bending.

However, it is envisaged in embodiments to realize the bending stiffness only with respect to the vertical. This is achieved in a (not depicted) embodiment by the bending head 18 being configured such that it is bending-resistant in one plane (containing the longitudinal direction), but bending-flexible in all others. To stabilize the tube material 4, the mandrel 14 is then rotated about its longitudinal axis by the switching device 27 in the state corresponding to FIG. 8, so that the bending-resistant plane of the mandrel head 18 coincides with the vertical. If the feed is then carried out as shown in FIG. 9, the tube material is sufficiently stabilized. To then carry out the bending as shown in FIG. 10, the mandrel 14 is rotated so that the bend-resistant plane coincides with the plane in which the bend lies. In the illustration in FIG. 10, this would be the drawing plane. Since the mandrel head 18 is only rigid against bending that would lead out of the plane, the mandrel head 18 can easily follow bends that run exclusively in the plane and can stabilize the inner cross-section of the tube material 4 during bending.

In this design, the switchover by the switching mechanism 27 is achieved by rotating the mandrel 14 in such a way that the plane in which the mandrel head 18 is resistant to bending coincides with the vertical in order to stabilize the tube material 4. During the bending process, however, the mandrel 14 is rotated so that the plane with respect to which it is rigid coincides with the plane in which the bend lies.

In the depicted embodiments, the mandrel 14 is realized by a guide rod 16 and a mandrel head 18. This two-part design is not mandatory. Depending on the design, the guide rod 16 can be shorter or longer or can be omitted altogether, i.e., the mandrel then consists only of the elements of the mandrel head 18.

Furthermore, the use of mandrel 14 was explained using a bending machine 2 that serially heats, advances and bends the tube material 4, i.e., performs individual bends one after the other. However, the advantages of mandrel 14 also apply equally to bending machines that do not move the tube material for bending and heat it over its entire length beforehand. Examples are machines that place the fully heated tube material in a bending mold or hold it with several robot arms and bend it. Here, too, the tube material must be supported after heating and stabilized in the inner cross-section during insertion or bending, which is where the convertible mandrel 14 comes into play.

In the embodiments explained, the mandrel and in particular the mandrel head 18 are held stationary relative to the tube material 4 during bending and are thereby switched to be slack (see FIG. 10). Depending on the design of the bending machine, however, it is also possible that the mandrel head 18, which is switched to be flexible, is moved during the bending process with respect to the tube material 4, for example, is slowly pulled out of the tube material 4 as the bending progresses. This is particularly realized in a bending machine that inserts the heated tube material into an upwardly open bending mold. In this case, it can be advantageous to withdraw the mandrel head from the tube material in a manner coordinated with the moving insertion. Alternatively, the mandrel head, which is switched to be rigid, can extend over the entire length of the tube material that is inserted into the bending mold and is only withdrawn from the heated tube material after it has been completely inserted into the bending mold. In both cases, the mandrel head is designed to be rigid in order to support the heated tube material while said heated tube material is being transported, for example to the bending mold. The same also applies to a design in which the tube material is held by robot arms and bent starting from one end without being conveyed. In these cases, it is also useful to switch the mandrel head to the slack state in the segments in which a bend is currently being executed or to slowly pull out the slack switched mandrel head from the end at which the bending begins, so that the flexible mandrel head always stabilizes the tube material in the inner cross-section exactly where a bend is being made. At the end of the process, the mandrel head is then completely pulled out of the tube material, which has all bends. Here, too, the mandrel head is switched to be resistant to bending in order to support the heated tube material during transport.

Insofar as this description refers to the mandrel head being switched to be resistant to bending, this naturally also includes the variant in which the mandrel head, which is resistant to bending in one plane, is rotated accordingly so that the plane in which the mandrel head is resistant to bending coincides with the vertical. Analogously, switching to the flexible state is to be understood such that the mandrel head is rotated such that a plane in which it is flexible coincides with the plane of an actual flexure in which the mandrel head is to stabilize the tube material in the inner cross-section.

In the embodiments described, the switching device that switches the mandrel head between being rigid and flexible is fully integrated into the mandrel drive or provided on the mandrel drive. This is an advantage for the bending machine 2 of FIG. 1 working along a machine bed. In other embodiments, however, it may be useful to provide at least part of the switching mechanism at the end of the mandrel independently of the bending machine, for example by means of a latching device which locks the pulling cable (22) in the biased or released state or the supporting device (for example the sleeve (30)) in the advanced or retracted state.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

What is claimed is:

1. A mandrel for heated thermoplastic tube material having an internal cross-section, the mandrel comprising:
a mandrel head switchable between a flexible state in which the mandrel head is flexible about a longitudinal axis and a rigid state in which the mandrel head is resistant to flexure at least relative to the vertical; and
a switching device comprising a mechanical drive acting on the mandrel head, wherein the switching device switches the mandrel head between the flexible state for stabilizing the tube material in the internal cross-section during a bending operation and the rigid state for supporting the heated tube material during transport.

2. The mandrel according to claim 1, wherein the mandrel head comprises a supporting element which is advanceable with respect to the mandrel head by insertion into the mandrel head or sliding over the mandrel head, and wherein the switching device advances the supporting element to switch the mandrel head to the rigid state.

3. The mandrel according to claim 2, wherein the mandrel head is supported by a rigid guide rod extending along the longitudinal axis, and the supporting element is arranged on the guide rod and advances along the longitudinal axis from the guide rod to the mandrel head in order to switch the mandrel head to the rigid state.

4. The mandrel according to claim 2, wherein the supporting element comprises a sleeve which engages around the mandrel head on the outside.

5. The mandrel according to claim 2, wherein the supporting element is pushed through an elongated opening into an internal cross section of the mandrel head.

6. The mandrel according to claim 1, wherein the mandrel head comprises a plurality of segments or scales arranged along a mandrel head extension and the switching device comprises a clamping element which braces the segments or scales together in order to switch the mandrel head to the rigid state.

7. The mandrel according to claim 6, wherein the clamping element comprises a guide cable which is fastened to the tip of the mandrel head and is placed under tensile stress in order to switch the mandrel head to the rigid state.

8. The mandrel according to claim 2, wherein the mandrel head comprises a spring element which extends along the longitudinal axis and is elastic transversely thereto and comprises an inner opening extending along the longitudinal axis, and the switching device comprises a supporting rod, the supporting rod being inserted rod into the inner opening to extend along the longitudinal axis through the mandrel head in order to switch the mandrel head to the rigid state.

9. The mandrel according to claim 1, wherein the mandrel head is flexible in a first plane containing the longitudinal axis and is otherwise rigid, the switching device orients the mandrel head such that the first plane is not in the vertical for switching to the rigid state, and the switching device rotates the mandrel head such that the first plane is in a bending plane for switching to the flexible state.

10. The mandrel according to claim 1, wherein the mandrel head is rigid in a second plane containing the longitudinal axis and is otherwise flexible, the switching device orients the mandrel head such that the second plane is in the vertical for switching to the rigid state, and the switching device rotates the mandrel head such that the second plane is essentially not a bending plane for switching to the flexible state.

11. The mandrel according to claim 1, wherein the mandrel head carries at least one widening element which is switchable to a radially expanded state having an outer diameter larger than the rest of the mandrel head, wherein the widening element is configured to be clamped internally in the tube material when in the radially expanded state to stabilize the tube material against torsion forces.

12. The mandrel according to claim 11, wherein the switching device switches the widening element to the radially expanded state simultaneously with bringing the mandrel head to the rigid state.

13. The mandrel according to claim 11, wherein the mandrel head comprises a guide cable which is fastened to the tip of the mandrel head and the switching device places the guide cable under tensile stress in order to switch the mandrel head to the rigid state, wherein the tensile stressed guide cable compresses the widening element to the radially expanded state.

14. A bending machine for bending heated thermoplastic tube material having an internal cross-section in at least one bending operation, the bending machine comprising:
a mandrel having a mandrel head switchable between a flexible state in which the mandrel head is flexible about a longitudinal axis and a rigid state in which the mandrel head is resistant to flexure at least relative to the vertical; and
a switching device comprising a mechanical drive acting on the mandrel head, wherein the switching device switches the mandrel head to the rigid state for transport of heated tube material and to the flexible state for stabilizing the tube material in the internal cross-section during the at least one bending operation.

15. A method for bending thermoplastic tube material comprising an inner cross-section, the method comprising:
heating a segment of the tube material to be bent to a bend disposed in a bending plane;
moving the tube material to a bending station;
supporting the segment with a mandrel having a mandrel head inserted into the inner cross-section along the segment, wherein the mandrel head is shiftable between a rigid state in which the mandrel head is resistant to flexing at least relative to the vertical during the moving step;
switching the mandrel head to a flexible state in which the mandrel head is flexible at least relative to the bending plane; and
bending the tube material in the segment while the mandrel head is in the flexible state.

16. The method according to claim 15, wherein the mandrel head comprises a supporting element which is advanced with respect to the mandrel head by insertion into the mandrel head or sliding over the mandrel head to bring the mandrel head to the rigid state.

17. The method according to claim 15, wherein the mandrel head comprises segments or scales which are braced together in order to bring the mandrel head to the rigid state.

18. The method according to claim 15, wherein the mandrel head is flexible in a first plane containing the longitudinal axis and is otherwise rigid, the mandrel head is oriented in the supporting step such that the first plane is not in the vertical, and the mandrel head is rotated in the switching step such that the first plane becomes located in the bending plane.

19. The method according to claim 15, wherein the mandrel head is rigid in a second plane containing the longitudinal axis and is otherwise flexible, the mandrel head is oriented for supporting step such that the second plane is in the vertical, and the mandrel head is rotated in the switching step such that the second plane is essentially not located in the bending plane.

20. A method for bending thermoplastic tube material comprising an inner cross-section, the method comprising:
heating a segment of the tube material to be bent to a bend disposed in a bending plane;
moving the tube material to a bending station;
while moving, supporting the segment by means of a mandrel having a rigid guide rod and a flexible mandrel head, wherein the mandrel is positioned such that rigid guide rod is located in the segment and the flexible mandrel head is outside the segment;
inserting the segment into the bending station and stabilizing the segment against the vertical by means of the bending station;
moving the flexible mandrel head to be located in the segment; and
bending the tube material in the segment.
